(19) United States
(12) Patent Application Publication
(10) Pub. No.: US 2006/0272705 A1
(43) Pub. Date: Dec. 7, 2006

(54) Buoyancy type drain trap

(76) Inventor: Toshimi Sugawara, Kanagawa (JP)

Correspondence Address: WENDEROTH, LIND & PONACK, L.L.P., 2033 K STREET N. W., SUITE 800, WASHINGTON, DC, 20006-1021, US

(21) Appl. No.: 11/445,295

(22) Filed: Jun. 2, 2006

(30) Foreign Application Priority Data
Jun. 6, 2005 (JP) 2005-192767

(51) Int. Cl. F16T 1/20

(52) U.S. Cl. 137/192

(57) ABSTRACT

Provided are a drain water discharging method and a buoyancy type drain trap in which a float is accommodated in a case and drain water allowed to flow into the case can be discharged by buoyancy acting on the float. In a case where an inner diameter of the valve is increased in order to increase a discharge flow rate at a valve connected to an outlet port formed in the case, the movement of a valve seat for opening the valve is facilitated through addition of some force to increase the buoyancy or through a reduction in a weight of the float itself.

### BACKGROUND OF THE INVENTION

1. Field of the Invention

The present invention relates to a technique of a buoyancy type drain trap, and more specifically, to a technique of discharging drain water accumulated in a drain trap by utilizing buoyancy with some force added thereto and by utilizing a suction force of a magnet.

2. Description of the Related Art

As a conventional technique related to a buoyancy type drain trap, there is known a structure having a float 200A accommodated in a case 100B.

In the following, the conventional buoyancy type drain trap will be described with reference to FIG. 8.

In FIG. 8, reference symbol 300K indicates a drain trap composed of the case 100B and the float 200A. The case 100B is integrally formed by a case main body 50, a float bracket 7, a valve 9, an adjustment screw 21, a packing 22, and manual valve 4 equipped with an O-ring. Further, the case main body 50 is integrally formed by a first case 1, a second case 2, and a gasket 3, and is completely sealed except for an inlet port 50a and an outlet port 50b so that no drain water leaks therefrom.

The float 200A is integrally formed by a float main body 5, an arm 6, and a rubber valve seat 8. In this case, the arm 6 is formed in a substantially L-shaped configuration. At one end of the arm 6, there is provided the float main body 5 which generates buoyancy when drain water flowing in through the inlet port 50a formed in the case 100B has been accumulated to a certain degree. Besides, at the other end of the arm 6, there is provided the rubber valve seat 8 that opens and closes the valve 9 connected to the outlet port 50b formed in the case 100B. Further, at the bent portion of the arm 6, rotation shafts 6a are formed, which are engaged with the float bracket 7 constituting a part of the case 100B inside the case 100B and which rotatably support the entire float 200A.

Thus, in a case where not much drain water has flowed into the case 100B yet, no buoyancy acts on the float main body 5, and the rubber valve seat 8 is held in intimate contact with the valve 9 due to a self-weight of the float 200A. As a result, the drain trap is kept in a closed state. In contrast, in a case where a lot of drain water has flowed into the case 100B to attain a level beyond a fixed position, buoyancy acts on the float main body 5, and the rubber valve seat 8 is separated from the valve 9 due to the buoyancy. As a result, the drain trap is brought into an open state. It should be noted, however, that the opening and closing of the valve 9 is also influenced by a force of compressed air pressure allowed to flow into the case 100B and act on the valve seat 9, and by an elastic force of the rubber valve seat 8.

However, the conventional drain water discharging method and the conventional buoyancy type drain trap described above have the following problems.

When an attempt is made to enlarge an inner diameter of the valve in order to increase a flow rate at both the inlet and outlet ports, the valve may become rather difficult to open or such the attempt may prove impossible.

Further, since the opening and closing of the valve seat is effected mainly by the self-weight of the float and the buoyancy due to the float main body, the valve seat is often allowed to remain in a half-open state, the opening and closing of the valve seat being rather uncertain.

### SUMMARY OF THE INVENTION

To solve the above-mentioned problem, the present invention provides the following solving structure.

According to the present invention, a buoyancy type drain trap includes: a float composed of an arm, a float main body provided at one end of the arm and capable of floating in water, a valve seat integrally provided at the other end of the arm, and a rotation shaft provided at a middle bent portion of the arm. Also, the buoyancy type drain trap includes a case integrally formed by a case main body having an inlet port through which drain water flows in and an outlet port through which drain water flows out, a valve connected to the outlet port, and a flow bracket at which the rotation shaft is situated to rotatably support the float, the rotation shaft being situated at the float bracket inside the case. In the buoyancy type drain trap, in a case where drain water has not flowed in to attain a fixed position in the case, the valve seat closes the valve by a self-weight G of the float, and in a case where drain water has flowed in to attain a position beyond the fixed position in the case, the valve seat opens the valve by buoyancy F of the float main body. The buoyancy type drain trap is characterized by further including an auxiliary buoyancy means for assisting an increase in the buoyancy F provided between the case and the float. Further, the buoyancy type drain trap is characterized in that the auxiliary buoyancy means is constructed of a coil spring provided between an adjustment screw and the arm to integrally hold the case main body and the float bracket by the adjustment screw and the valve. Still further, the buoyancy type drain trap is characterized in that a compression force of the coil spring can be adjusted by varying a thickness of an adjustment washer situated between the float bracket and the adjustment screw. Yet further, the buoyancy type drain trap is characterized in that the auxiliary buoyancy means is constructed of a compression spring arranged between the case main body and the float main body. Furthermore, the buoyancy type drain trap is characterized by further including: a magnet arranged at some position on the arm between the float main body and the rotation shaft; and an associated member for generating an suction force by the magnet arranged at some position inside the case, in which a relationship in terms of moment between the buoyancy F of the float, the suction force of the magnet, the self-weight G of the float, and positions X, Y, and Z where these forces are generated, and the relationship in terms of moment between the elastic force of the valve seat, the compression force of the coil spring, and a position K where these forces are generated, are summed up. Moreover, the buoyancy type drain trap is characterized in that the associated member is constructed of a plate spring and a plate spring bracket supporting the plate spring at some position inside the case. Thus, the present invention has solved the problems described above.

The drain trap of the present invention, which is constructed as described above provides the following effects.

First, in a drain water discharging method which makes it possible to discharge drain water having flowed into the case accommodating the float by buoyancy acting on the float, when the inner diameter of the valve connected to the outlet port formed in the case is enlarged in order to increase the discharge flow rate at the valve, movement of a rubber valve seat when opening the valve is facilitated by adding some force to enhance the buoyancy or by reducing a weight of the float itself, whereby it is possible to discharge drain water smoothly.

Second, even in a case where an attempt is made to enlarge the inner diameter of the valve in order to increase the flow rate at the outlet port, the movement of the rubber valve seat when opening the valve is facilitated by positioning the coil spring or the compression spring between the case and the float as a device for adding some force, whereby it is possible to discharge drain water smoothly.

Third, even in a case where an attempt is made to enlarge the inner diameter of the valve in order to increase the flow rate at the outlet port, the movement of the rubber valve seat when opening the valve is facilitated by arranging, as the auxiliary buoyancy device, the coil spring between the adjustment screw and the arm so as to be integrated with the adjustment screw and the valve while holding the case main body and the float bracket, with the compression force of the coil spring being adjustable by varying the thickness of an adjustment washer situated between the float bracket and the adjustment screw. Consequently, it is possible to discharge drain water smoothly.

Fourth, by positioning the magnet between the case and the float, the suction force is generated, and, by taking into consideration the relationship between the buoyancy of the float, the suction force of the magnet, the self-weight of the float, and the positions where these forces are generated, and the relationship between the elastic force of the rubber valve seat, the compression force of the coil spring, and the position where these forces are generated, it is possible to prevent the valve seat from being constantly left in a half-open state due to the uncertainty of the opening and closing of the valve seat.

### BRIEF DESCRIPTION OF THE DRAWINGS

In the accompanying drawings:

FIG. 1 is a sectional view of a drain trap according to the present invention with its valve closed;

FIG. 2 is a sectional view of a drain trap according to the present invention with its valve open;

FIG. 3 is a perspective view of an arm and a rubber valve seat forming a drain trap according to the present invention;

FIG. 4 is an enlarged sectional view of a valve forming a drain trap according to the present invention and the periphery thereof;

FIG. 5 is a sectional view of another drain trap according to the present invention with its valve closed;

FIG. 6 is a sectional view of still another drain trap according to the present invention with its valve closed;

FIG. 7 is a schematic view of a relationship between forces exerted around a float forming a drain trap according to the present invention; and

FIG. 8 is a sectional view of a conventional drain trap with its valve closed.

### DETAILED DESCRIPTION OF THE PREFERRED EMBODIMENTS

In the following, embodiments of the present invention will be described in detail with reference to the drawings.

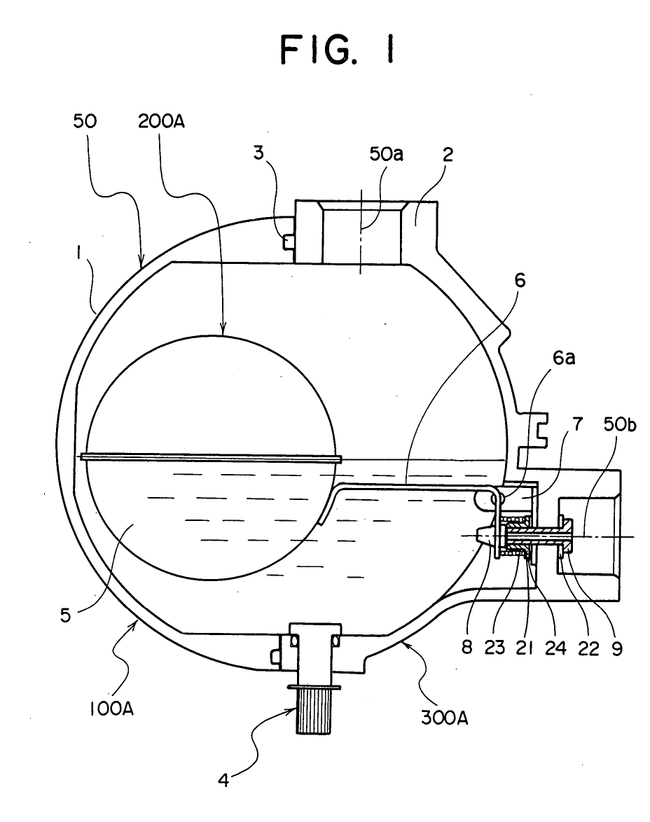

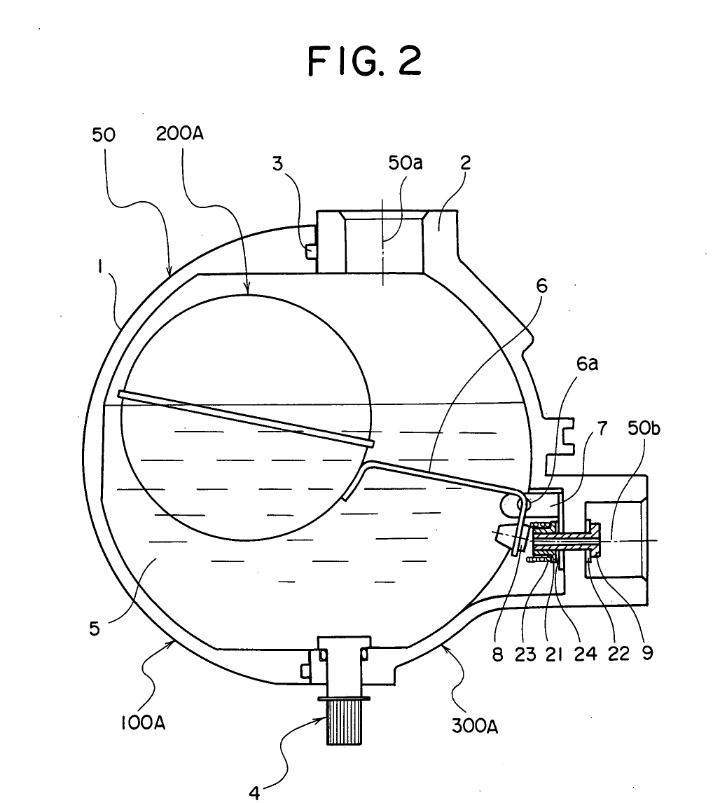

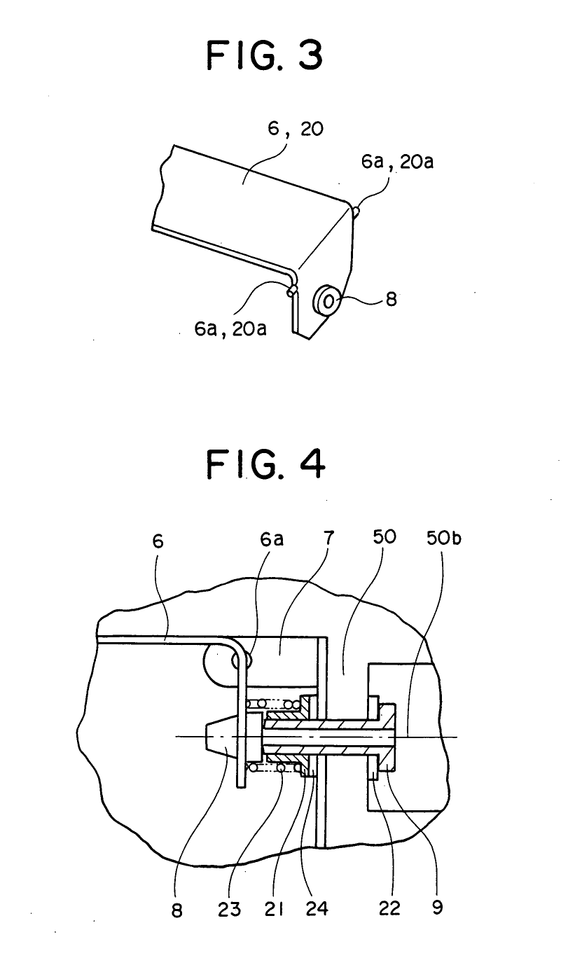

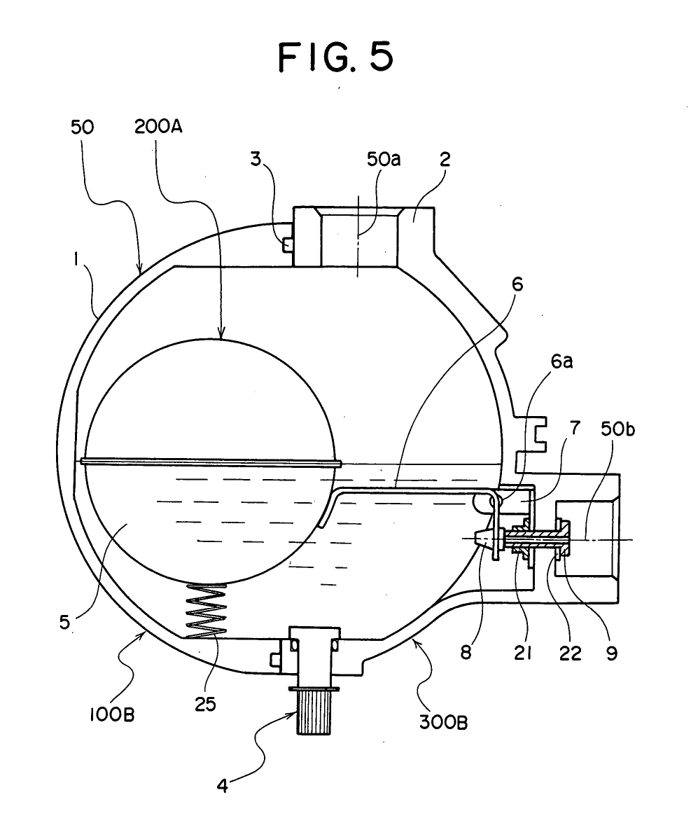

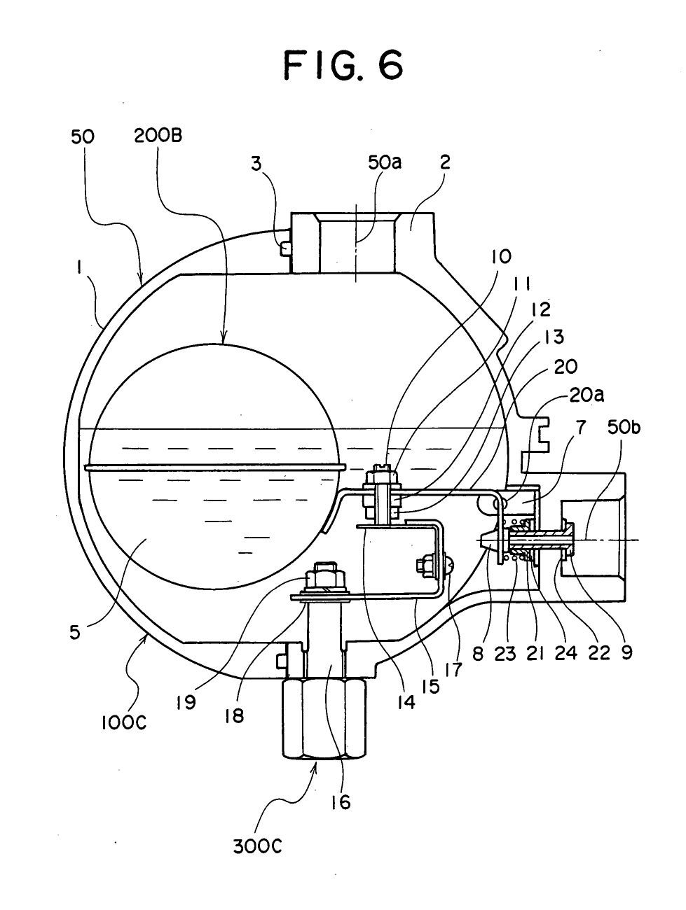

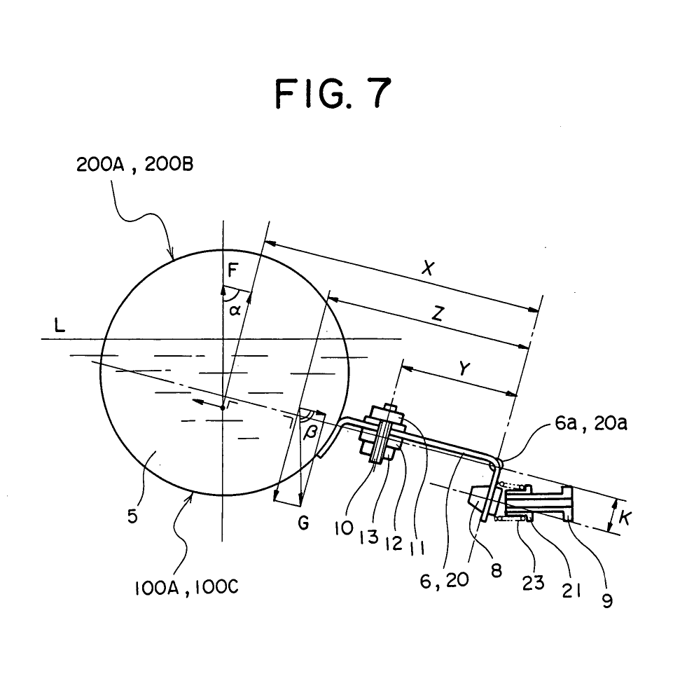

Here, FIG. 1 is a diagram showing a drain trap according to the present invention with its valve closed; FIG. 2 is a diagram showing a drain trap according to the present invention with its valve open; FIG. 3 is a diagram showing an arm and a rubber valve seat forming a drain trap according to the present invention; FIG. 4 is a detailed view of a valve forming a drain trap according to the present invention and the peripheral portions thereof; FIG. 5 is a diagram showing another drain trap according to the present invention with its valve closed; FIG. 6 is a diagram showing still another drain trap according to the present invention with its valve closed; and FIG. 7 is a diagram showing the relationship between forces exerted around a float forming a drain trap according to the present invention.

### First Embodiment

As shown in FIGS. 1, 2, 3, 4, and 7, reference symbol 300A indicates a drain trap which is composed of a case 10A, a float 200A, and a coil spring 23 serving as an auxiliary buoyancy device situated between the case 100A and the float 200A.

The case 100A is integrally formed by a case main body 50, a float bracket 7, a valve 9, an adjustment screw 21, an adjustment washer 24, a packing 22, and manual valve 4 equipped with an O-ring.

As shown in detail in FIG. 4, the valve 9 in this example is equipped with a flange, and the flange side of the valve 9 is situated on the outer side of the case main body 50 with the packing 22 therebetween. Further, the valve 9 is connected to the case main body 50 through thread engagement, and the other end thereof on the opposite side of the flange, that is, a screw portion protrudes into the case main body 50. The protruding portion has the adjustment screw 21 equipped with a flange, the flange side of the adjustment screw 21 being positioned such that the adjustment washer 24 is held between the adjustment screw 21 and the inner side of the case main body 50. Accordingly, the adjustment screw 21 is connected with the valve 9 through thread engagement. Thus, the valve 9 is constructed such that drain water flows from the side where there exists the adjustment screw 21 forming the screw portion on the inner side of the case main body 50 to the side where there exists the packing 22 forming the flange on the outer side of the case main body 50.

In a case where there are prepared various adjustment washers 24 differing in thickness so as to allow replacement, it is possible to adjust the compression amount of the coil spring 23 situated between the arm 6 constituting the float 200A described in detail below, and the adjustment screw 21 which constitutes an integral unit in which there are arranged the case main body 50 constituting the case 10A, the adjustment washer 24, and the adjustment screw 21 in the stated order with the valve 9 extending therethrough. Thus, it is possible to adjust the compression force generated by the coil spring 23.

Further, the case main body 50 is integrally composed of a first case 1, a second case 2, and a gasket 3, and is completely sealed except for an inlet port 50a and an outlet port 50b so that no drain water leaks therefrom.

The float 200A is integrally composed of a hollow float main body 5, the arm 6, and the rubber valve seat 8. In this case, the arm 6 is formed in a substantially L-shaped configuration. At one end of the arm 6, there is provided the float main body 5 which generates buoyancy F when drain water flowing in through the inlet port 50a formed in the case 100A has been accumulated to a certain degree. Besides, at the other end of the arm 6, as shown in FIG. 3, there is provided the rubber valve seat 8 that opens and closes the valve 9 connected to the outlet port 50b formed in the case 100A. Further, at the bent portion of the arm 6, rotation shafts 6a are formed, which are engaged with the float bracket 7 formed inside the case 100A and which rotatably support the entire float 200A.

However, the configuration of the arm 6 is not restricted to the substantially L-shaped configuration. It is also possible for the arm 6 to adopt a substantially U-shaped configuration or some other configuration. Further, regarding the angle of the bent portion of the arm 6, the angle may be 90 degrees or more or 90 degrees or less. In addition, regarding the arm 6, it may be positioned so as to be parallel to the water surface L in a case where the rubber valve seat 8 keeps the valve 9 closed. However, it may also be positioned so as not to be parallel to the water surface. Further, it is also possible to form the arm 6 in a substantially I-shaped configuration of a flat plate, with the rubber valve seat 8 and the valve 9 being positioned not coaxially but at a right angle with respect to each other.

In a case where drain water flows into the case 100A as shown in FIG. 1 or flows out therefrom as shown in FIG. 2, the entire float 200A rotates around the rotation shafts 6a, making it possible for the rubber valve seat 8 to open or close the valve 9. While the rubber valve seat 8 keeps the valve 9 closed, an elastic force is generated.

While the rubber valve seat 8 keeps the valve 9 closed, both the compression force due to the coil spring 23 and the elastic force due to the rubber valve seat 8 are generated; whereas, while the rubber valve seat 8 keeps the valve 9 open, the coil spring 23 and the rubber valve seat 8 have been expanded to the utmost, so no compression force or elastic force is generated. However, during the transition period, generation of the compression force due to the coil spring 23 may only be happened.

In the following, the operation of the drain water discharging method and the buoyancy type drain trap of the present invention constructed as described above will be illustrated.

First, drain water flows into the case 101A of the drain trap 300A through the inlet port 50a. As shown in FIGS. 1 and 4, in a case where no or little drain water has flowed into the case 100A yet, the arm 6, which rotates around the rotation shafts 6a formed thereon, keeps the rubber valve seat 8 in intimate contact with the valve 9 due to the self-weight G of the float 200A and the compressed air pressure exerted on the sectional area of the flow passage of the valve 9.

While the rubber valve seat 8 is held in intimate contact with the valve 9, the compression force due to the coil spring 23 and the elastic force due to the rubber valve seat 8 are both generated. However, as soon as the rubber valve seat 8 opens the valve 9, the elastic force due to the rubber valve seat 8 ceases to be exerted, and when the rubber valve 8 is further separated from the valve 9, the compression force due to the coil spring 23 also ceases to be exerted.

As the amount of drain water in the case 100A increases, there is generated the buoyancy F to a degree corresponding to the amount of drain water displaced by the hollow float main body 5 as shown in FIG. 2. In other words, as will be illustrated with reference to FIG. 7, since the float main body 5 is a sphere, the buoyancy F is exerted upwards toward the center of the sphere. In contrast, the weight G of the float 200A as a whole is constantly exerted downwards.

Here, equation 1 is to be derived from FIG. 7. In the case of the first embodiment, equation 1 is applicable to a case in which an adjustment screw 10, a nut 11, a magnet seat 12, and a magnet 13 are removed from the construction as shown in FIG. 7.

M=(the buoyancy F of the float main body 5)×sin α×X−(the self-weight G of the float 200A)×sin β×Z+{(the elastic force of the rubber valve seat 8)+(the compression force of the coil spring 23)}×K−(the sectional area of the flow passage of the valve 9)×(the compressed air pressure)×K, [Equation 1]

where, X represents the minimum distance from the rotation shafts 6a to the center of the buoyancy F of the float main body 5 as measured along the arm 6 or an extension thereof;

Z represents the minimum distance from the rotation shafts 6a to the center of the self-weight G of the float 200A as measured along the arm 6 or an extension thereof;

K represents the distance from the rotation shafts 6a to the center of the rubber valve seat 8 on the arm 6;

α represents the angle made by the vertical line along which the buoyancy F is generated and the arm 6; and

β represents the angle made by the vertical line along which the self-weight G is generated and the arm 6.

In reality, the buoyancy F, the self-weight G, and the arm 6 are,-often in the same plane; in that case, α=β.

Thus, when the value of M is negative, the rubber valve seat 8 keeps the valve 9 closed as shown in FIGS. 1 and 4, and when the value of M is positive, the rubber valve seat 8 keeps the valve 9 open as shown in FIGS. 2 and 7. That is, the above-mentioned condition to be satisfied varies depending on the magnitude of the buoyancy F of the float main body 5, the self-weight G of the float 200A, the elastic force of the rubber valve seat 8, the compression force of the coil spring 23, the sectional area of the flow passage of the valve 9, the compressed air pressure, and the distances X, Z, and K between the rotation shafts 6a and the positions where the above-mentioned forces are exerted. Further, as the amount of drain water increases, the buoyancy F of the float main body 5 and the self-weight G of the float 200A also vary depending on the angles α and β which are made by the vertical lines, along which the buoyancy F of the float main body 5 and the self-weight G of the float 200A are generated, and the arm 6.

### Second Embodiment

Referring to FIGS. 5 and 7, reference symbol 300B indicates a drain trap which is composed of a case 100B, a float 200A, and a compression spring 25 situated between the case 100B and the float 200A and serving as an auxiliary buoyancy device 25.

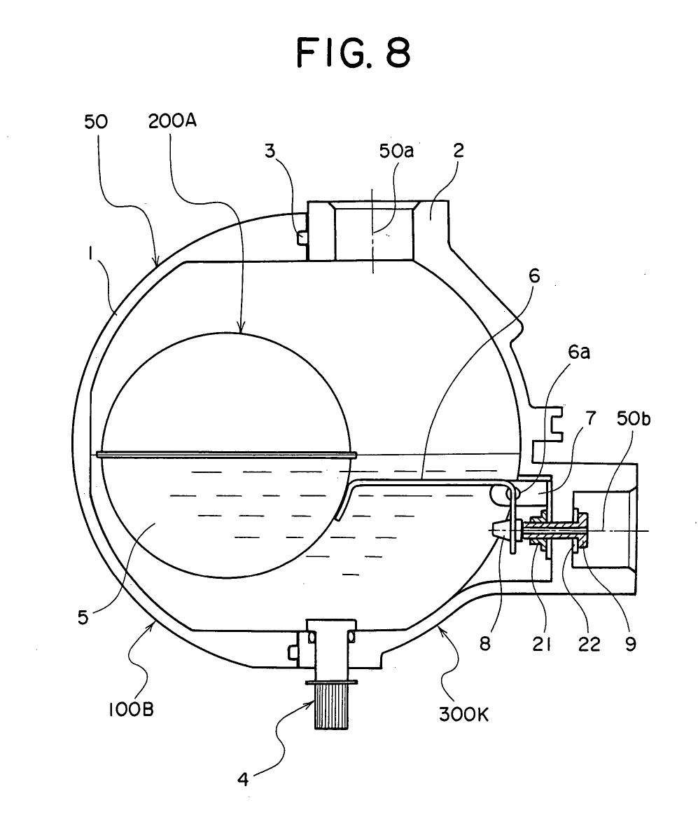

In this case, the case 100B is the same as that of the conventional technique as shown in FIG. 8, and the float 200A is the same as that of the first embodiment as shown in FIG. 1, so description thereof will be omitted.

Thus, the second embodiment differs from the first embodiment in that the compression spring 25 serving as the auxiliary buoyancy device is situated between the case main body 50 constituting the case 100B and the float main body 5 constituting the float 200A. Regarding the compression spring 25, one end thereof may be fixed to the case main body 50 with the other end thereof not being fixed to the float main body 5, so that when the float main body 5 rises due to the buoyancy F, the compression spring 25 is detached there from to allow no compression force to be exerted. In some cases, the other end may be fixed to the float main body 5 so that a tensile force is exerted during the rise of the float main body 5.

In the following, the operation of the drain water discharging method and the buoyancy type drain trap of the present invention constructed as described above will be illustrated.

First, drain water flows into the case 100B of the drain trap 300B through the inlet port 50a. When no or little drain water has flowed into the case 100B, the arm 6, which rotates around the rotation shafts 6a formed thereon, keeps the rubber valve seat 8 in intimate contact with the valve 9 due to the self-weight G of the float 200A and the compressed air pressure exerted on the sectional area of the flow passage of the valve 9.

While the rubber valve seat 8 is held in intimate contact with the valve 9, the compression force due to the compression spring 25 and the elastic force due to the rubber valve seat 8 are both generated. However, as soon as the rubber valve seat 8 opens the valve 9, the elastic force due to the rubber valve seat 8 ceases to be exerted, and when the rubber valve 8 is further separated from the valve 9, the compression force due to the compression spring 25 also ceases to be exerted. Unlike the coil spring 23 of the first embodiment situated near the valve 9, the compression force of the compression spring 25 can be constructed so as to be capable of exerting the compression force even when the valve 9 is opened and is considerably separated from the rubber valve seat 8. Further, it is also possible to construct the spring such that the tensile force begins to be exerted when the spring has been expanded to the utmost and the compression force has ceased to be exerted.

As the amount of drain water in the case 100B increases, there is generated the buoyancy F to a degree corresponding to the amount of drain water displaced by the hollow float main body 5. In other words, as will be illustrated with reference to FIG. 7, since the float main body 5 is a sphere, the buoyancy F is exerted upwards toward the center of the sphere. In contrast, the weight G of the float 200A as a whole is constantly exerted downwards.

Here, equation 2 is to be derived from FIG. 7. In the case of the second embodiment, equation 2 is applicable to a case in which the adjustment screw 10, the nut 11, the magnet seat 12, and the magnet 13 are removed from the construction as shown in FIG. 7. Further, although not shown specifically in FIG. 7, instead of the compression force of the coil spring 23, the compression force of the compression spring 25 is exerted vertically upwards at the center of the lower portion of the float main body 5.
M=(the buoyancy F of the float main body 5)×sin α×X−(the self-weight G of the float 200A)×sin β×Z+(the elastic force of the rubber valve seat 8)×K−(the sectional area of the flow passage of the valve 9)×(the compressed air pressure)×K+(the compression force of the compression spring 25)×sin α×(the minimum distance from the rotation shafts 6a to the center of the compression force of the compression spring 25 as measured along the arm 6 or an extension thereof), [Equation 2]
where, X represents the minimum distance from the rotation shafts 6a to the center of the buoyancy F of the float main body 5 as measured along the arm 6 or an extension thereof;

Z represents the minimum distance from the rotation shafts 6a to the center of the self-weight G of the float 200A as measured along the arm 6 or an extension thereof;

K represents the distance from the rotation shafts 6a to the center of the rubber valve seat 8 on the arm 6;

α represents the angle made by the vertical line along which the buoyancy F is generated and the arm 6; and

β represents the angle made by the vertical line along which the self-weight G is generated and the arm 6.

In reality, the buoyancy F, the self-weight G, and the arm 6 are often in the same plane; in that case, α=β.

Thus, when the value of M is negative, the rubber valve seat 8 keeps the valve 9 closed as shown in FIG. 5, and when the value of M is positive, the rubber valve seat 8 keeps the valve 9 open as shown in FIG. 7. That is, the above-mentioned condition to be satisfied varies depending on the magnitude of the buoyancy F of the float main body 5, the self-weight G of the float 200A, the elastic force of the rubber valve seat 8, the compression force of the compression spring 25, the sectional area of the flow passage of the valve 9, the compressed air pressure, and the distances X, Z, and K between the rotation shafts 6a and the positions where the above-mentioned forces are exerted. Further, as the amount of drain water increases, the buoyancy F of the float main body 5 and the self-weight G of the float 200A also vary depending on the angles α and β which are made by the vertical lines, along which the buoyancy F of the float main body 5 and the self-weight G of the float 200A are generated, and the arm 6.

### Third Embodiment

Referring to FIGS. 6 and 7, reference symbol 300C indicates a drain trap which is composed of a case 100C, a float 200B, and a compression spring 23 situated between the case 100C and the float 200B and serving as an auxiliary buoyancy device.

In this case, regarding the case 100C, as shown in FIG. 6, instead of the manual valve 4 of the case 100A of the first embodiment of FIG. 1, there are provided a stay 16, a washer 18, a nut 19, a plate spring bracket 15, a fixation screw 17, and a plate spring 14; regarding the float 200B, instead of the arm 6 of the float 200A of the first embodiment equipped with the rotation shafts 6a, there is formed an arm 20 equipped with rotation shafts 20a; and further, there are added an adjustment screw 10, a nut 11, a magnet seat 12, and a magnet 13.

Thus, the third embodiment differs from the first embodiment in that, in addition to the force of FIG. 1, there is to be expected an suction force due to the magnet 13 and the plate spring 14 situated on the arm 20 constituting the float 200B at a position between the float main body 5 and the rotation shafts 20a, whereby it is possible to prevent the rubber valve seat 8 and the valve 9 from being left in a half-open state due to the uncertainty of the opening and closing of the valve seat 8.

Regarding the magnet 13 constituting the float 200B, the nut 11 and the magnet seat 12 are set with the arm 20 therebetween, and the three components are fixed together by the adjustment screw 10, with the magnet 13 and the magnet seat 12 being fixed together by the magnetic suction force. Further, the adjustment screw 10 allows adjustment of the distance between the plate spring 14 constituting the case 100C.

The plate spring 14 is of a substantially L-shaped configuration, and is fixed to a substantially J-shaped plate spring bracket 15 by the fixation screw 17, with the plate spring bracket 15 being fixed to the stay 16 by the washer 18 and the nut 19. The stay 16 is fixed to the lower portion of the case main body 50 through thread engagement. While, in this example, the magnet 13 is provided on the float 200B side, it may also be provided on the case 100C side.

The configuration of the plate spring 14 is not restricted to the substantially L-shaped configuration, and the plate spring 14 may also be formed in a substantially I-shaped configuration of a flat plate or some other configuration. Further, the configuration of the plate spring bracket 15 is not restricted to the J-shaped configuration either, and the plate spring bracket 15 may be of a substantially L-shaped configuration or some other configuration.

Here, the plate spring bracket 15 also serves as a constraining device, which helps to prevent the right-angle portion of the substantially L-shaped plate spring 14 from having an angle of 90 degrees or more due to the suction force that is exerted when the plate spring 14 is attracted by the magnetic force of the magnet 13. Thus, while this suction force is larger than the buoyancy F, that is, when the buoyancy F is still small and the rubber valve seat 8 has not opened the valve 9 yet, the valve 9 is kept closed by this suction force.

In the following, the operation of the drain water discharging method and the buoyancy type drain trap of the present invention constructed as described above will be illustrated.

First, drain water flows into the case 100C of the drain trap 300C through the inlet port 50a. In a case where no or little drain water has flowed into the case 100C, the arm 20, which rotates around the rotation shafts 20a formed thereon, keeps the rubber valve seat 8 in intimate contact with the valve 9 due to the self-weight G of the float 200B and the compressed air pressure exerted on the sectional area of the flow passage of the valve 9. Further, while the rubber valve seat 8 is held in intimate contact with the valve 9, the suction force of the magnet 13 is added.

While the rubber valve seat 8 is held in intimate contact with the valve 9, the compression force due to the coil spring 23 and the elastic force due to the rubber valve seat 8 are both generated. However, as soon as the rubber valve seat 8 opens the valve 9, the elastic force due to the rubber valve seat 8 ceases to be exerted, and when the rubber valve 8 is further separated from the valve 9, the compression force due to the coil spring 23 also ceases to be exerted.

As the amount of drain water in the case 100C increases, there is generated the buoyancy F to a degree corresponding to the amount of drain water displaced by the hollow float main body 5. In other words, as will be illustrated with reference to FIG. 7, since the float main body 5 is a sphere, the buoyancy F is exerted upwards toward the center of the sphere. In contrast, the weight G of the float 200B as a whole is constantly exerted downwards.

Here, equation 3 is to be derived from FIG. 7.
M=(the buoyancy F of the float main body 5)×sin α×X−(the self-weight G of the float 200B)×sin β×Z−(the suction force of the magnet 13)×Y+{(the elastic force of the rubber valve seat 8)+(the compression force of the coil spring 23)}×K−(the sectional area of the flow passage of the valve 9)×(the compressed air pressure)×K, [Equation 3]
where, X represents the minimum distance from the rotation shafts 20a to the center of the buoyancy F of the float main body 5 as measured along the arm 20 or an extension thereof;

Y represents the distance from the rotation shafts 20a to the center of the magnet 13 on the arm 20;

Z represents the minimum distance from the rotation shafts 20a to the center of the self-weight G of the float 200B as measured along the arm 20 or an extension thereof;

K represents the distance from the rotation shafts 20a to the center of the rubber valve seat 8 on the arm 20;

α represents the angle made by the vertical line along which the buoyancy F is generated and the arm 20; and

β represents the angle made by the vertical line along which the self-weight G is generated and the arm 20.

In reality, the buoyancy F, the self-weight G, and the arm 20 are often in the same plane; in that case, α=β.

Thus, when the value of M is negative, the rubber valve seat 8 keeps the valve 9 closed as shown in FIG. 6, and when the value of M is positive, the rubber valve seat 8 keeps the valve 9 open as shown in FIG. 7. That is, the above-mentioned condition to be satisfied varies depending on the magnitude of the buoyancy F of the float main body 5, the self-weight G of the float 200B, the suction force of the magnet 13, the elastic force of the rubber valve seat 8, the compression force of the coil spring 23, the sectional area of the flow passage of the valve 9, the compressed air pressure, and the distances X, Z, and K between the rotation shafts 20a and the positions where the above-mentioned forces are exerted. Further, as the amount of drain water increases, the float main body 5 and the self-weight G of the float 200B also vary depending on the angles α and β which are made by the vertical lines, along which the buoyancy F of the float main body 5 and the self-weight G of the float 200B are generated, and the arm 6.

The third embodiment of the present invention shown in FIG. 6, to which the magnet 13 and the construction and function related thereto are added to the first embodiment shown in FIG. 1, is also applicable to, as a modification, an invention in which the magnet 13 and the construction and function related thereto are added to the second embodiment shown in FIG. 5.

Further, instead of using the coil spring 23 and the compression spring 25 as auxiliary buoyancy devices 23 and 25 for increasing the buoyancy F, it is possible to use an elastic material for the substantially L-shaped arm 6 and 20, and to set the arm at an angle several degrees larger than 90 degrees, whereby it is possible to cause the arm to function as an auxiliary buoyancy device.

Further, instead of forming the rubber valve seat 8 with rubber, it is also possible to form with resin, metal, etc.

What is claimed is:

1. A buoyancy type drain trap, comprising:
a float (200A, 200B) composed of an arm (6, 20), a float main body (5) provided at one end of the arm and capable of floating in water, a valve seat (8) integrally provided at the other end of the arm, and a rotation shaft (6a, 20a) provided at a middle bent portion of the arm; and
a case (10A, 100B, 100C) integrally formed by a case main body (50) having an inlet port (50a) through which drain water flows in and an outlet port (50b) through which drain water flows out, a valve (9) connected to the outlet port (50b), and a flow bracket (7) at which the rotation shaft (6a, 20a) is situated to rotatably support the float (200A, 200B), the rotation shaft (6a, 20a) being situated at the float bracket (7) inside the case (100A, 10DB, 100C),
wherein, in a case where drain water has not flowed into attain a fixed position in the case (100A, 100B, 100C), the valve seat (8) closes the valve (9) by a self-weight (G) of the float (200A, 200B), and in a case where drain water has flowed in to attain a position beyond the fixed position in the case (100A, 100B, 100C), the valve seat (8) opens the valve (9) by buoyancy (F) of the float main body (5), and
wherein the buoyancy type drain trap further comprises an auxiliary buoyancy means (23, 25) for assisting an increase in the buoyancy (F) provided between the case (100A, 100B, 100C) and the float (200A, 200B).

2. A buoyancy type drain trap according to claim 1, wherein the auxiliary buoyancy means (23) comprises a coil spring (23) provided between an adjustment screw (21) and the arm (6) to integrally hold the case main body (50) and the float bracket (7) by the adjustment screw (21) and the valve (9).

3. A buoyancy type drain trap according to claim 2, wherein a compression force of the coil spring (23) can be adjusted by varying a thickness of an adjustment washer (24) situated between the float bracket (7) and the adjustment screw (21).

4. A buoyancy type drain trap according to claim 1, wherein the auxiliary buoyancy means (25) comprises a compression spring (25) arranged between the case main body (50) and the float main body (5).

5. A buoyancy type drain trap according to claim 1, further comprising:
a magnet (13) arranged at some position on the arm (20) between the float main body (5) and the rotation shaft (20a); and
an associated member (14, 15) for generating an suction force by the magnet (13) arranged at some position inside the case (100C),
wherein a relationship in terms of moment between the buoyancy (F) of the float (200B), the suction force of the magnet (13), the self-weight (G) of the float (200A), and positions (X, Y, Z) where these forces are generated, and the relationship in terms of moment between the elastic force of the valve seat (8), the compression force of the coil spring (23), and a position (K) where these forces are generated, are summed up.

6. A buoyancy type drain trap according to claim 2, further comprising:
a magnet (13) arranged at some position on the arm (20) between the float main body (5) and the rotation shaft (20a); and
an associated member (14, 15) for generating an suction force by the magnet (13) arranged at some position inside the case (100C),
wherein a relationship in terms of moment between the buoyancy (F) of the float (200B), the suction force of the magnet (13), the self-weight (G) of the float (200A), and positions (X, Y, Z) where these forces are generated, and the relationship in terms of moment between the elastic force of the valve seat (8), the compression force of the coil spring (23), and a position (K) where these forces are generated, are summed up.

7. A buoyancy type drain trap according to claim 3, further comprising:
a magnet (13) arranged at some position on the arm (20) between the float main body (5) and the rotation shaft (20a); and
an associated member (14, 15) for generating an suction force by the magnet (13) arranged at some position inside the case (100C),
wherein a relationship in terms of moment between the buoyancy (F) of the float (200B), the suction force of the magnet (13), the self-weight (G) of the float (200A), and positions (X, Y, Z) where these forces are generated, and the relationship in terms of moment between the elastic force of the valve seat (8), the compression force of the coil spring (23), and a position (K) where these forces are generated, are summed up.

8. A buoyancy type drain trap according to claim 4, further comprising:
a magnet (13) arranged at some position on the arm (20) between the float main body (5) and the rotation shaft (20a); and
an associated member (14, 15) for generating an suction force by the magnet (13) arranged at some position inside the case (100C),
wherein a relationship in terms of moment between the buoyancy (F) of the float (200B), the suction force of the magnet (13), the self-weight (G) of the float (200A), and positions (X, Y, Z) where these forces are generated, and the relationship in terms of moment between the elastic force of the valve seat (8), the compression force of the coil spring (23), and a position (K) where these forces are generated, are summed up.

9. A buoyancy type drain trap according to claim 5, wherein the associated member (14, 15) comprises a plate spring (14) and a plate spring bracket (15) supporting the plate spring (14) at some position inside the case (100C).
